(19) United States
(12) Patent Application Publication
(10) Pub. No.: US 2006/0133306 A1
(43) Pub. Date: Jun. 22, 2006

(54) Method for selecting resources in communication networks

(76) Inventors: Ralf Neuhaus, Lunen (DE); Rainer Uecker, Mulheim (DE)

Correspondence Address: Siemens Corporation;Intellectual Property Department, 170 Wood Avenue South, Iselin, NJ, 08830, US

(21) Appl. No.: 10/520,682

(22) PCT Filed: Jun. 6, 2003
(86) PCT No.: PCT/DE03/01890

§ 371 Date: Jan. 7, 2005

(30) Foreign Application Priority Data
Jul. 8, 2002 (DE) 10230689.3

(51) Int. Cl. H04J 3/08; H04B 7/14

(52) U.S. Cl. 370/315

(57) ABSTRACT

In order to select resources in inventive communication networks comprising communication components that use said network resources, in a first step, the functions and data regarding the performance of several or all resources are determined and stored by a communication component. Additionally, resource-specific information regarding the use of said resource is stored in at least one data base when a resource is used by a communication component. The resource is selected according to the stored functions and data and/or the resource-specific information stored in the database.

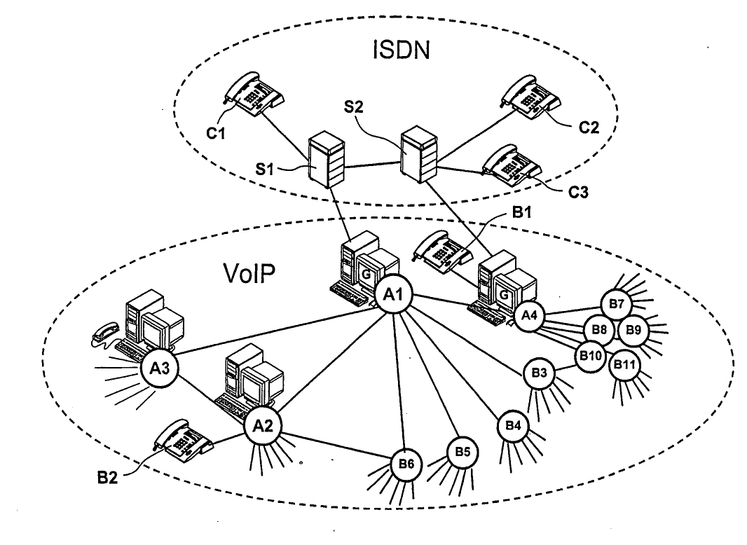

### CROSS REFERENCE TO RELATED APPLICATIONS

This application is the US National Stage of International Application No. PCT/DE03/01890, filed Jun. 6, 2003 and claims the benefit thereof. The International Application claims the benefits of German application No. 10230689.3 DE filed Jul. 8, 2002, both of the applications are incorporated by reference herein in their entirety.

### FIELD OF INVENTION

This invention relates to a method and a computer program for selecting resources in communication networks.

### BACKGROUND OF INVENTION

Communication networks whose components communicate with one another on a packet-switched basis are replacing circuit-switching communication networks to an increasing extent. Such networks are frequently also referred to as Voice over IP (VoIP for short) networks when the Internet protocol (IP) is used for interchanging the audio information provided in the form of data. In this case, the networks may either be used exclusively for transmitting voice data or else for transmitting a mixture of voice data and other information.

The interconnected devices arranged in communication networks are referred to generally as communication components. When a communication component of this type is used as a terminal, for example as a telephone or a multimedia terminal, this component is also referred to as a client component. Other components are not used as a terminal, but rather provide services in the communication network. The services may be a gateway functionality, a voicemail server, an address directory or the like, for example. Such communication components are also referred to as server components. The services and functions provided by the server components are frequently referred to as resources in the literature.

Both the client components and the server components normally comprise a piece of computer hardware (for example a PC) which uses appropriate hardware extensions and a piece of adapted software to perform appropriate functionalities. In this case, a piece of computer hardware may also have more than one software application installed on it, which means that a single physical component in the network may in principle exercise both client and server functionalities. Such communication components are also referred to as servents in the literature, an artificial word derived from the terms “client” and “server”.

The communication components connect to one another by interchanging addressed data packets with one another. In this case, each communication component in the packet-switching network has a network address which is uniquely associated with it. In the networks which interchange data on the basis of the Internet protocol (IP networks), this is the IP address and the IP port number, for example. If a communication component is intended to connect to or interchange data with another communication component, then it is first necessary to find out the network address of the other component. The network addresses are not always permanently associated with the communication components over time, but rather may also be allocated dynamically in the network, which means that communication components may each have a different address whenever they have been turned off and turned on again or after predetermined events. For this reason, at least one network component in the known packet-switching communication networks is equipped with an address directory (address database) for all of the communication components which are available in the communication network. These server components are normally referred to as gatekeepers.

Alternatively, data interchange without a central address database in the manner of a gatekeeper is known, for example using the “The Gnutella Protocol Specification V 0.4” method, which communication components on the Internet can automatically use to find other communication components for file interchange. In this case, the file and hence data interchange thus takes place not using a central server component or a “gatekeeper”, but rather directly between the individual communication components. Networks which provide direct data interchange between communication components without a superordinate entity are called peer-to-peer networks. The communication components which comprise both “client” and “server” functionalities are the aforementioned “servents”.

In the peer-to-peer network based on the Gnutella specification, each communication component (for example a PC) holds files ready for interchange with other communication components. In order to be able to interchange data, the searching communication component requires the network address of the communication component which holds the sought file ready for retrieval. To this end, it first of all sends a first search message, the “ping”. Communication components which receive a “ping” search message respond to the searching communication component using a hit response, the “pong”. This hit response contains the respective network address of the responding communication component and the number of files which this communication component provides for interchange. In the next step, the searching communication component sends a second search message “Query” to a limited selection of those communication components which have responded to the “ping” search message with a “pong”. The second search message already contains the file name of the file which is being sought. If a communication component receives a second search message “Query” but does not itself hold the sought file ready for interchange, then it forwards this search message to other communication components in the communication network whose addresses it has ascertained, for example by means of a “ping” method which has already been carried out in the past. If the communication component can provide the desired file for interchange, however, then it responds to the second search message “Query” with a hit response “Query Hit”, as a result of which the searching communication component can initiate the file transfer using commands defined in the Internet protocol.

The Gnutella method is used when a particular file is being sought among other communication components. The search method is terminated at the very instant at which the sought file has been found for the first time.

The document U.S. application Ser. No. 1-2002/073204 Dutta et al. “Method and system for exchange of node characteristics for data sharing in peer-to-peer data networks” shows a packet-switched communication network having communication components (computer) in which which interchange computer files with one another. In this case, the files are sought and transferred on the basis of the Gnutella protocol. In this context, the user of a computer is shown characteristic information about the quality of the connection to one of the other computers found, this information relating firstly to the access parameters for this computer found and secondly to the transfer speed (bit rate) of the connection. The information displayed also includes the names of the files which are stored on this computer and can be used for file interchange. The information is displayed to the user of the computer, which means that he can then decide whether a connection to the other computer found is to remain for the purpose of file interchange or whether this connection needs to be cleared down. In this case, any computer may in principle both provide files and obtain files from other computers.

While the correct file need only be found once when searching on the basis of the Gnutella method, it is frequently important in the case of the services in communication networks—the resources—to gain access to a plurality of resources of the same type in order to be able to choose between them when required. This case frequently arises with gateways, for example, which provide the client components in packet-switching communication networks with connections to communication components in circuit-switching communication networks. In this context, the client components in a packet-switching communication network require the use-related information about a plurality of server components of this type, because the gateways always support only a limited number of communication connections at the same time in line with their number of channels. Hence, if a gateway is already being utilized to the full extent, it is necessary to be able to move to another gateway.

The document U.S. application Ser. No. 1-2002/064147 Jonas et al. “Method and apparatus for transmitting and routing voice telephone calls over a packet switched computer network” shows a method and an arrangement for communication connections (telephone calls) which are routed across networks between a first communication component (computer) in a first communication network (data network, Internet) and a second communication component (telephone) in a second circuit-switched communication network (public telephone network). For this, the two communication networks, that is to say the Internet and the public telephone network, are linked to one another by means of gateways. For communication connections which are set up to the circuit-switched communication network from the computer network, this communication component first sets up a connection to a central “authentication server”, which in turn selects one of the gateways for the communication connection which is to be set up on the basis of the current utilization level and the respective costs.

If a packet-switching communication network has a plurality of gateways available, then it is normal for client components to have stored a list containing a plurality of gateways. In searching for a free gateway, that is to say one which is not yet fully utilized, a client component successively contacts all of the gateways which the list contains until a gateway with sufficient (residual) capacity has been found. In this case, the first gateway on this list is also referred to as the “default gateway” and the other gateways on this list are also referred to as “fall-back gateways”. The list containing the available resources in the communication network is administered from a central location in the communication network. In the event of changes to the network topology or in the event of changes in relation to the available server components, the list is changed and is then made available to the client components again in updated form.

Gateways and other resources in the communication network are reserved in multiple fashion primarily for capacity reasons. In this case, these communication components are normally physically distributed in the communication network. This firstly shortens the connection path on average and secondly results in cost advantages, particularly in the case of gateways. A demanded high level of failsafety is also a reason to reserve central components in multiple fashion in communication networks.

It has been found to be a disadvantage with the known communication networks that resources which are already in use or are not so suitable are selected at the time of use.

### SUMMARY OF INVENTION

It is an object of the invention to make the selection of resources in packet-switching communication networks more effective and at the same time to reduce the involvement for administering the communication networks.

This object is achieved for a method and a computer program product by the features specified in the claims.

In relation to the method, the way in which this object is achieved is that when a resource is being used by a communication component the database is used to store resource-specific information about the use of this resource, and the resource is selected on the basis of the resource-specific information stored in the database and on the basis of statistical information about the previous use of this resource.

In this case, simple means are used to ensure that when a particular resource is used a plurality of times or in the longer term, not just statements relating to the performance but also empirical values from previous instances of use of this resource are taken into account.

Advantageous refinements of the invention are specified in the claims.

In this case, information sent by the resources is statistically evaluated and stored for the purpose of storing the resource-specific information. By way of example, resource-specific information is information about the reliability, the safety, the availability, the costs for use of the resource etc.

Advantageously, the resource-specific information stored by a communication component can be provided for other communication components, which means that not every communication component is limited to the information in its own database or needs to set up its own database independently.

### BRIEF DESCRIPTION OF THE DRAWING

An exemplary embodiment of the inventive method is described below with reference to the drawing.

To this end, the single figure shows a schematic illustration of a packet-switching communication network which is connected to a circuit-switching communication network.

### DETAILED DESCRIPTION OF INVENTION

Communication components A11-A4, B1-B11 in a packet- switching communication network VoIP are connected to one another.

The communication components A1-A4, B3-B11 are servents which thus have both client and server functionalities. The communication components B1, B2 are “simple” IP telephones, that is to say communication components with pure client functionality.

The communication components A1, A4 contain, as a server functionality, gateways which connect the packet-switching communication network VoIP to the circuit-switching communication network ISDN. The gateways installed on the communication components A1 and A4 are situated at various locations and also in different secondary distribution network areas of the circuit-switching communication network ISDN. The gateways permit connections between the communication components A1-A4, B1-B11 in the packet-switching communication network VoIP and the circuit-switching communication systems S1, S2, to which ISDN terminals C1-C3 are connected. They are available as useable resources to all client components in the packet-switching communication network VoIP and also to the communication installations S1, S2 in the circuit-switching communication network ISDN.

The gateways installed on the communication components A1, A4 may be selected and used by the client components of the communication components B1, B2 and also by all client components installed in the packet-switching communication network VoIP on the communication components A1-A4, B3-11-predominantly in the form of software applications. To this end, all communication components A1-A4, B3-B11 have a piece of communication software installed on them which provides the client functionality.

The communication software is designed such that it also respectively examines its own communication component A1-A4, B3-B11 to determine which server functionalities can be provided. This is done at least when the communication software is started for the first time. This information regarding the server functionalities is then stored such that it can be retrieved by the other communication components A1-A4, B3-B11 using appropriate search methods.

The text below uses the example of the communication component A3 to describe the search for resources in the packet-switching communication network VoIP, the selection of one of a plurality of gateways as resources and the use of the selected gateway for the purpose of a communication connection between the communication component A3 and the ISDN terminal C1 in the circuit-switching communication network ISDN.

When the communication component A3 has started and the above-described examination of the dedicated hardware has taken place, the client component of the communication component A3 searches the packet-switching communication network VoIP for other, “adjacent” communication components. To this end, methods defined in the Internet protocol are used which request all components in a network segment to send a response message. This is done by means of a “broadcast”, that is to say a message sent to all components which can be reached. In the course of this search, the communication component A3 ascertains and stores the network addresses of the communication components A1 and A2. In the next step, the communication component A3 sends search messages containing the demand for resources of a particular type, namely for gateways, to the “adjacent” communication components A1 and A2 found.

The communication component A3 has been preset such that it uses this search method to search only for resources of such a type which will probably or Empirically be used more frequently. This include gateways which allow connections between the packet-switching communication network VoIP and the circuit-switching communication network ISDN. Other resources which are used less often, for example servers for conducting telephone conferences, are sought in the packet-switching communication network VoIP only when the client component installed on the component A3 demands the use of such a resource.

In this example, the communication software for the communication component A3 in the packet-switching communication network VoIP searches exclusively for gateways, because this is the resource type used most often in this case.

The communication component A2 does not have its own gateway, which means that it forwards the search query from the communication component A3 to further communication components A4, B5, B6 itself.

By contrast, the communication component A1 has a gateway of its own and responds to the search query from the communication component A3 with a positive response which includes the network address of the communication component A1 and the access parameters for the gateway installed thereon. These statements are stored in a table by the communication component A3.

In addition, the communication component A1 forwards the search message to other communication components B3, B10, B11 which are known to it.

The communication component A4 likewise has a gateway of its own, which means that it responds to the search query from the communication component A3, which it has received via the “detour” through the communication component A2, in the same way, with the response comprising the network address of the communication component A4 and the access parameters for the gateway installed thereon, in a similar manner to the case of the communication component A1. These statements are also stored in the table of available gateways by the communication component A3.

The search messages which are forwarded from the communication component A3 to its adjacent communication components A1 and A2 and from these in turn to further communication components contain, in a predefined data field, a number which is reduced by 1 as a counter whenever the search message is forwarded from one communication component to the next communication component. As soon as this number has reached the value 0 as a result of continued forwarding of the search message, the search message is no longer transferred further in the packet-switching communication network VoIP. This prevents the search message from being forwarded infinitely often. The start value for this counter is set to be sufficiently high in the communication component A3, which means that a larger portion of the packet-switching communication network VoIP or the entire packet-switching communication network VoIP is searched. In this case, the number has the value 10, for example.

Besides from the communication components A1 and A4, the communication component A3 receives no further responses.

When the communication component A3 has found the two gateways which are available in the packet-switching communication network VoIP and are installed on the communication components A1 and A4, the order is now stipulated in which these gateways are connected as soon as the client component installed on the communication component A3 which is to set up a communication connection to a terminal C1 to C3 in the circuit-switching communication network ISDN. To this end, the communication component A3 sends each of the two gateways found a series of test messages. A test message of this type is the “PING”, for example, which is in very common use on the Internet for checking the connection to other communication components. These test messages are answered by the communication components A1 and A4 using an appropriate standardized response. The period of time between transmission of the test message by the communication component A3 and reception of the corresponding response is referred to as the propagation time for the test message. The propagation times of the test messages are measured and stored by the communication component A3. The propagation times for all test messages to a gateway are used to form a respective mean value, which is added to the entries in the resource table. The mean propagation times are now used to sort the table such that the gateway with the shortest mean propagation time is in first place. In the next step, the communication component A3 sends each of the gateways found a request message which is used to request the service features of the gateways. By way of example, these respectively include the number of voice channels to the circuit-switching communication network ISDN and the bandwidth of the link between the gateways and the packet-switching communication network VoIP. The information about the service features which is obtained as a result of these requests is also stored in the table in the communication component A3.

A sorting criterion which may be used for the resources of a particular type may now also be, besides the mean propagation time for the test messages, the other available statements—such as the number of channels or the bandwidth of the IP link. In the present case, the list has been sorted using the mean propagation time for the test messages so as, when setting up a connection, to process this list starting with the resource having the shortest mean propagation time and to select that resource which first meets the requirements regarding bandwidth and number of channels which need to be met in order to set up the pending connection. If this resource cannot set up the desired connection, for example because it is currently being used by the communication component B3 or has failed in the meantime, the next suitable resource from the list is selected etc.

The communication component A3 does not just enter statements such as the mean propagation times, the bandwidth of the IP link and the available number of channels etc. into the list of available resources, but rather also gathers statistical information about its own use of these resources in this list in parallel. This information may also be referred to as an “empirical database” about the reliability, safety and availability of the resources. With a large number of resources of the same type in a packet-switching communication network VoIP, such statistical information is also evaluated in order to stipulate the order of use of the resources on the basis of this information. In this case, by way of example, those resources which have a low failure or termination rate or have been rarely “engaged” to date are used in preference. These statistical statements are provided by the communication component A3 for retrieval by other communication components A1, A2, B3 to B11 as well so that communication components A1, A2, B3 to B11 which have been newly added or turned on may also select resources in optimum fashion from the outset.

If one of the communication components A1 and A4 or one of the gateways installed thereon fails, then the next gateway shown in the list of communication component A3 is used as a substitute. So that the failed resource is not repeatedly contacted in vain when resources have failed for a longer period, the communication component A3 performs a connection test for all of the resources shown at regular intervals of time. In addition to this, the search for resources in the packet-switching communication network VoIP is also regularly repeated so that communication components newly added to the network in the meantime and their resources are found and are thus useable.

1-11. (canceled)

12. A method for selecting resources in a communication network, the network having communication components which use the resources in the network, a plurality of resources provide the communication components with a same function, comprising
determining and storing a function and a resource performance-statement about by the communication component;
storing resource-specific information in a database if a resource is being used by the communication component; and
selecting the resource based on the resource-specific information and statistical information about the previous use of this resource.

13. The method as claimed in claim 12, wherein the function is the functionality of the resource.

14. The method as claimed in claim 12, wherein the function is the functionality of the component.

15. The method as claimed in claim 12, wherein the resource-specific information includes statistically evaluated information sent by the resource.

16. The method as claimed in claim 12, wherein the resource-specific information includes reliability information of the resource.

17. The method as claimed in claim 12, wherein the resource-specific information includes safety information of the resource.

18. The method as claimed in claim 12, wherein the resource-specific information includes availability information of the resource.

19. The method as claimed in claim 12, wherein the resource-specific information can be provided to other communication components.

20. The method as claimed in claim 12, wherein the resource are the useable services of communication components.

21. The method as claimed in claim 12, wherein the communication component has a search function for determining the address of resources of further communication components.

22. The method as claimed in claim 12, wherein a reaction time of the resource is taken into account for the statement.

23. The method as claimed in claim 12, wherein a present utilization level of the resource is taken into account for the statement.

24. The method as claimed in claim 12, wherein a remaining capacity of the resource is taken into account for the statement.

25. The method as claimed in claim 12, wherein if the resource being used by the communication component fails then the communication component selects the next available resource with the same function for further use.

26. The method as claimed in claim 12, wherein if the resource being used by the communication component fails then the communication component selects the next available resource with the same function for further use.

27. The method as claimed in claim 12, further comprising ascertaining resource data after the communication component has been turned on, the resource data selected from the group consisting of the functions, the statements and a combination thereof.

28. The method as claimed in claim 27, wherein the resource data is ascertained at stipulated time intervals.

29. A computer program adapted to operate within a communication network, the communication network having communication components that use a resource in the network, comprising
a database including information about the resource;
a module for finding an address of further communication components;
a module for checking an availability of the resource and for ascertaining a performance of the resource;
a module that stores resource-specific information about the use of the resource when the resource in the database is being used; and
a module for selecting a resource based on resource data selected from the group consisting of the resource-specific information stored in the database and statistical information about the previous use of the resource.

30. The computer program as claimed in claim 29, wherein the resource-specific information includes reliability, cost, and safety information.

31. The computer program as claimed in claim 29, wherein the statistical information is received from another component.
